(19) United States
(12) Patent Application Publication
(10) Pub. No.: US 2025/0330819 A1
(43) Pub. Date: Oct. 23, 2025

(54) METHOD AND DEVICE FOR DETERMINING SIZE OF BUFFER OF DATA LINK LAYER L2

(71) Applicant: Beijing Xiaomi Mobile Software Co., Ltd., Beijing (CN)

(72) Inventor: Qin MU, Beijing (CN)

(21) Appl. No.: 18/870,040

(22) PCT Filed: Jun. 2, 2022
(86) PCT No.: PCT/CN2022/097013

§ 371 Date: Nov. 27, 2024

(51) Int. Cl. H04W 16/02; H04L 27/26; H04L 47/36

(52) U.S. Cl. CPC H04W 16/02; H04L 27/26025; H04L 47/36

(57) ABSTRACT

A method for determining a size of a buffer of a data link layer L2, the method includes: determining a maximum frequency resource occupiable by a data channel corresponding to the terminal device; and determining the size of the buffer of the data link layer L2 in the terminal device based on the maximum frequency resource.

### CROSS-REFERENCE TO RELATED APPLICATIONS

The present application is a U.S. National Stage of International Application No. PCT/CN2022/097013, filed on Jun. 2, 2022, the contents of all of which are incorporated herein by reference in their entirety for all purposes.

### BACKGROUND OF THE DISCLOSURE

For a traditional new radio (NR) terminal device, all physical resource blocks (PRBs) in a bandwidth part (BWP) can be used by the terminal device. However, for a reduced capability (RedCap) terminal device, a BWP with a large bandwidth, such as a 20 MHz BWP, can be configured for the terminal device by a network. Nevertheless, resources used for data channels are typically constrained, that is, less than the bandwidth of the BWP. For example, the bandwidth of a data channel supported by the RedCap terminal device is constrained to be no greater than 5 MHz. However, a transport block is still transmitted or processed with all PRBs of the BWP in the related art, which results in an anomaly in transmission or processing of the transport block.

### SUMMARY OF THE DISCLOSURE

The present disclosure relates to the technical field of data processing, and in particular to a method and device for determining a size of a buffer of a data link layer L2.

In a first aspect, a method for determining a size of a buffer of a data link layer L2 is provided according to the embodiments of the present disclosure. The method is performed by a terminal device and includes: determining a maximum frequency resource occupiable by a data channel corresponding to the terminal device; and determining the size of the buffer of the L2 in the terminal device based on the maximum frequency resource.

In a second aspect, a method for determining a size of a buffer of a data link layer L2 is provided according to the embodiments of present disclosure. The method is performed by a network device and includes: determining a maximum frequency resource occupiable by a data channel corresponding to the terminal device; and transmitting a transport block to the terminal device based on the maximum frequency resource and according to a parameter of the buffer of the L2 of the terminal device, where a size of the buffer of the L2 is determined by the maximum frequency resource.

In a third aspect, a communication device is provided according to the embodiments of the present disclosure. The communication device includes one or more processors; and a memory. A computer program is stored in the memory. The one or more processors execute the computer program stored in the memory to cause the communication device to determine a maximum frequency resource occupiable by a data channel corresponding to the terminal device; and determine the size of the buffer of the data link layer L2 in the terminal device based on the maximum frequency resource.

In a fourth aspect, a communication device is provided according to the embodiments of the present disclosure. The communication device includes one or more processors and a memory. A computer program is stored in the memory. The one or more processors execute the computer program stored in the memory to cause the communication device to perform the method described by the second aspect.

In a fifth aspect, a non-transitory computer-readable storage medium is provided according to the embodiments of the present disclosure. The non-transitory computer-readable storage medium is configured to store instructions for the terminal device described above. When the instructions are executed by one or more processors, the one or more processors implement the method described by the first aspect.

In a sixth aspect, a non-transitory readable storage medium is provided according to the embodiments of the present disclosure. The non-transitory readable storage medium is configured to store instructions for a network device described above. When the instructions are executed by one or more processors, the one or more processors implement the method described by the second aspect.

### BRIEF DESCRIPTION OF DRAWINGS

In order to more clearly illustrate the embodiments of the present disclosure or the technical solution in the related art, the accompanying drawings required for the embodiments of the present disclosure or the related art will be explained below.

FIG. 1 is a schematic diagram of an architecture of a communication system according to an embodiment of the present disclosure;

FIG. 2 is a schematic flowchart of a method for determining a size of a buffer of a data link layer L2 according to an embodiment of the present disclosure;

FIG. 3 is a schematic flowchart of a method for determining a size of a buffer of a data link layer L2 according to an embodiment of the present disclosure;

FIG. 4 is a schematic flowchart of a method for determining a size of a buffer of a data link layer L2 according to an embodiment of the present disclosure;

FIG. 5 is a schematic flowchart of a method for determining a size of a buffer of a data link layer L2 according to an embodiment of the present disclosure;

FIG. 6 is a schematic flowchart of a method for determining a size of a buffer of a data link layer L2 according to an embodiment of the present disclosure;

FIG. 7 is a schematic flowchart of a method for determining a size of a buffer of a data link layer L2 according to an embodiment of the present disclosure;

FIG. 8 is a schematic structural diagram of a communication device according to an embodiment of the present disclosure;

FIG. 9 is a schematic structural diagram of a communication device according to an embodiment of the present disclosure; and

FIG. 10 is a schematic structural diagram of a chip according to an embodiment of the present disclosure.

### DETAILED DESCRIPTION OF THE DISCLOSURE

The example embodiments will be described in detail here, and examples thereof are shown in the accompanying drawings. In a case where the following description relates to the accompanying drawings, the same numbers in different accompanying drawings refer to the same or similar elements, unless otherwise indicated. The embodiments described in the following examples do not represent all embodiments consistent with the embodiments of the present disclosure. Rather, they are merely instances of devices and methods consistent with some aspects of the appended claims of the present disclosure.

Terms used in the embodiments of the present disclosure are for the purpose of describing particular embodiments merely, and not intended to limit the embodiments of the present disclosure. As used in the embodiments of the present disclosure, singular forms such as “a”, “an”, and “the/said” are intended to include plural forms as well, unless otherwise indicated in the context clearly. It should be understood that the term “and/or” as used here refers to and encompasses any or all possible combinations of at least one of associated listed items.

It should be understood that although the terms first, second, third, etc. may be used in the embodiments of the present disclosure to describe various information, these information should not be limited to these terms. These terms are merely used to distinguish the same type of information from each other. For example, first information may also be referred to as second information, and similarly, second information may also be referred to as first information, without departing from the scope of the embodiments of the present disclosure. The word “if” as used here may be construed as “at the time of”, “in a case where”, or “in response to determining” depending on the context.

For the purpose of concision and easy understanding, the terms “greater than” or “less than”, and “higher than” or “lower than” are used here to denote a magnitude relationship. However, those skilled in the art can understand that the term “greater than” also encompasses the meaning of “greater than or equal to”, and the term “less than” also encompasses the meaning of “less than or equal to”; and the term “higher than” encompasses the meaning of “higher than or equal to”, and the term “lower than” also encompasses the meaning of “lower than or equal to”.

For ease of understanding, terms involved in the present disclosure are introduced at first.

Bandwidth part (BWP): different bandwidths configured on the same terminal device are referred to as bandwidth parts.

Physical resource block (PRB): the physical resource block refers to resources of twelve consecutive carriers in a frequency domain.

Transport block (TB): the transport block is configured to describe a preferred character set transmitted as a single unit or block in a computer system.

Data link layer L2: the data link layer is a second layer in an open system interconnect (OSI) reference model and is located between a physical layer and a network layer. The data link layer provides services to the network layer based on services provided by the physical layer. A most basic service is to reliably transmit data originating from the network layer to a target machine network layer of a neighboring node. A second layer of a Uu interface protocol in a mobile communication system is also referred to as layer 2 or L2.

In order to better understand a method for determining a size of a buffer of a data link layer L2 disclosed in the embodiments of the present disclosure, a communication system to which the embodiments of the present disclosure is applicable is first described below.

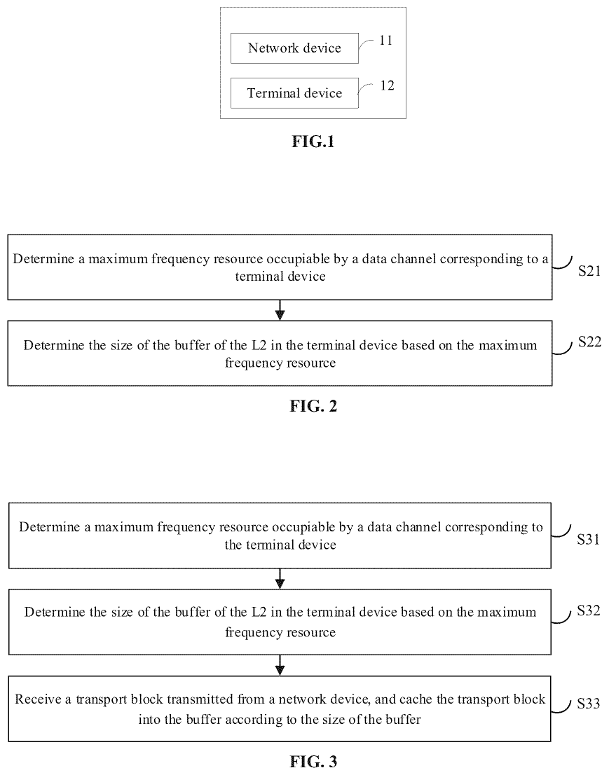

With reference to FIG. 1, FIG. 1 is a schematic diagram of an architecture of a communication system according to an embodiment of the present disclosure. The communication system may include, but is not limited to, one network device and one terminal device. The number and form of devices shown in FIG. 1 are only illustrative and do not constitute a limitation to the embodiment of the present disclosure. The communication system may include two or more network devices and two or more terminal devices in an actual application. For example, the communication system shown in FIG. 1 includes one network device 11 and one terminal device 12.

It should be noted that the technical solution of the embodiment of the present disclosure may be applied to various communication systems, for example, a long term evolution (LTE) system, a 5th generation (5G) mobile communication system, a 5G new radio system, and other future new mobile communication systems. It should also be noted that a sidelink in the embodiments of the present disclosure may also be referred to as a sidewalk link or a through link.

The network device 101 in the embodiment of the present disclosure is an entity on a network side for transmitting or receiving signals. For example, the network device 11 may be an evolved NodeB (eNB), a transmission reception point (TRP), a next generation NodeB (gNBs) in an NR system, a base station in other future mobile communication systems, or an access node in a wireless fidelity (WiFi) system, etc. The embodiment of the present disclosure does not limit a particular technology and a particular device form used by the network devices. The network device provided in the embodiment of the present disclosure may be composed of a central unit (CU) and a distributed unit (DU). The CU may also be referred to as a control unit. By using a CU-DU structure, protocol layers of the network device, such as a base station, may be split. Functions of some protocol layers are centrally controlled by the CU, and functions of some or all of the remaining protocol layers distributed in the DU are centrally controlled by the CU.

The terminal device 12 in the embodiment of the present disclosure is an entity on a user side configured to receive or transmit signals, such as a mobile phone. The terminal device may also be referred to as a terminal, user equipment (UE), a mobile station (MS), a mobile terminal (MT), etc. The terminal device may be a car with a communication function, a smart car, a mobile phone, a wearable device, a Pad, a computer with a radio transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in smart home, etc. The embodiment of the present disclosure does not limit a particular technology and a particular device form used by the terminal device.

In sidelink communication, there are four sidelink transmission modes. Sidelink transmission mode 1 and sidelink transmission mode 2 are used for device-to-device (D2D) communication. Sidelink transmission mode 3 and sidelink transmission mode 4 are used for V2X communication. In a case where sidelink transmission mode 3 is used, resource allocation is scheduled by a network device 11. Specifically, the network device 11 may transmit resource allocation information to the terminal device 12, and the terminal device 12 allocates resources to another terminal device. In this way, another terminal device may transmit information to the network device 11 through the allocated resources. In V2X communication, a terminal device with a better signal or higher reliability may be used as the terminal device 12. A first terminal device mentioned in the embodiments of the present disclosure may refer to the terminal device 12, and a second terminal device may refer to another terminal device.

It can be understood that the communication system described in the embodiments of the present disclosure is for more clearly illustrating the technical solutions provided in the embodiments of the present disclosure, and does not constitute a limitation on the technical solutions provided in the embodiments of the present disclosure. Those skilled in the art may know that the technical solutions provided in the embodiments of the present disclosure are also applicable to similar technical problems along with evolution of a system architecture and emergence of new service scenes.

The method and a device for determining a size of a buffer of a data link layer L2 provided in the present disclosure are described in detail below in conjunction with the accompanying drawings.

With reference to FIG. 2, FIG. 2 is a flowchart of a method for determining a size of a buffer of a data link layer L2 according to an embodiment of the present disclosure. The method for determining a size of a buffer of a data link layer L2 is performed by a terminal device. The method may include: S21, determining a maximum frequency resource occupiable by a data channel corresponding to the terminal device.

Alternatively, the data channel corresponding to the terminal device may include a physical downlink shared channel (PDSCH) and a physical uplink shared channel (PUSCH).

Alternatively, the maximum frequency resource occupiable by the data channel corresponding to the terminal device may be determined based on a protocol agreement, or indication information transmitted from a network device, or a configuration parameter of the terminal device. For example, the network device may schedule resources for the terminal device, and indicate the resources to the terminal device through the indication information. Correspondingly, the terminal device may receive the indication information for indicating the maximum frequency resource occupiable by the data channel corresponding to the terminal device from the network device. For example, the terminal device may receive radio resource control (RRC) signaling, downlink control information (DCI), or other signaling transmitted from the network device, and determine the maximum frequency resource based on configuration information of the RRC signaling, the DCI, or other signaling. For another example, the terminal device may determine the maximum frequency resource occupiable by the data channel corresponding to the terminal device according to a communication protocol. For instance, the maximum frequency resource occupiable by the data channel corresponding to RedCap UE may be 20 MHz, the maximum frequency resource occupiable by the data channel corresponding to eRedCap UE may be 5 MHz, and so on. For another example, the maximum frequency resource occupiable by the data channel corresponding to the terminal device may be determined according to the configuration parameter of the terminal device. For instance, in a case where the maximum frequency resource occupiable by the data channel supported by the RedCap UE may be 20 MHz, but configuration information of the RedCap UE is set to a maximum frequency resource of nMHz (n<20), the maximum frequency resource occupiable by the data channel corresponding to the RedCap UE may be nMHz.

It should be noted that the maximum frequency resource occupied by the data channel corresponding to the terminal device is no greater than a maximum bandwidth supported by the terminal device. Alternatively, the maximum frequency resource occupied by the data channel corresponding to the terminal device is no greater than a maximum bandwidth of a bandwidth part (BWP) configured for the terminal device. A frequency resource occupied by the data channel may be several PRBs continuous in frequency, also be several PRBs spaced in frequency. In other words, the frequency resource occupied by the data channel may be continuous or discontinuous in the BWP. Thus, the maximum frequency resource occupiable by the data channel corresponding to the terminal device is no greater than the maximum bandwidth supported by the terminal device. For instance, in a case where the maximum frequency resource occupiable by the data channel supported by the RedCap UE may be 20 MHz, but configuration information of the RedCap UE is set to a maximum frequency resource of nMHz (n<20), the maximum frequency resource occupiable by the data channel corresponding to the RedCap UE may be nMHz.

S22, the size of the buffer of the L2 in the terminal device is determined based on the maximum frequency resource.

The buffer is provided in the terminal device for the L2. A transport block received by the terminal device can be cached through the buffer. This helps prevent the loss of transport blocks when the terminal device is unable to decode them in time due to an excessive number of received transport blocks.

In the present disclosure, a maximum storage capacity of the buffer of L2 in the terminal device for the transport block may be determined by the maximum frequency resource occupiable by the data channel corresponding to the terminal device. In other words, the larger the maximum frequency resource is, the larger a size or a transmission rate of the transport block that may be supported by the terminal device is. Alternatively, the size of the buffer may be determined based on the maximum frequency resource in a manner of a protocol agreement or a network indication.

According to a method for processing a transport block provided in the present disclosure, the size of the buffer of the L2 in the terminal device may be determined based on the maximum frequency resource occupiable by the data channel supported by the terminal device. In the present disclosure, the size of the buffer of the L2 is no longer determined by the maximum frequency resource of a BWP. Instead, the determined size of the buffer is adapted to the resource of the terminal device, eliminating the resource waste caused by the oversized buffer. In some scenarios, the resource waste caused by the oversized buffer can be eliminated, as can the overflow of received downlink transmission caused by the undersized buffer of the L2 of the terminal device.

In the embodiment of the present disclosure, the maximum frequency resource occupiable by the data channel corresponding to the terminal device is the maximum bandwidth supported by the terminal device. Alternatively, the maximum frequency resource occupied by the data channel may be semi-statically configured, i.e., the maximum frequency resource corresponding to the terminal device does not change after access to a cell, or a base station or a network. In a possible implementation, the maximum frequency resource occupied by the data channel may be semi-statically configured through the RRC signaling. Alternatively, the maximum frequency resource occupied by the data channel corresponding to the terminal device may be dynamically configured, i.e., the maximum frequency resource occupied by the data channel corresponding to the terminal device is dynamically configured by a network side through the DCI signaling. In the following embodiments, the maximum frequency resource occupiable by the data channel corresponding to the terminal device may also be determined by those methods, which will not be repeatedly described below.

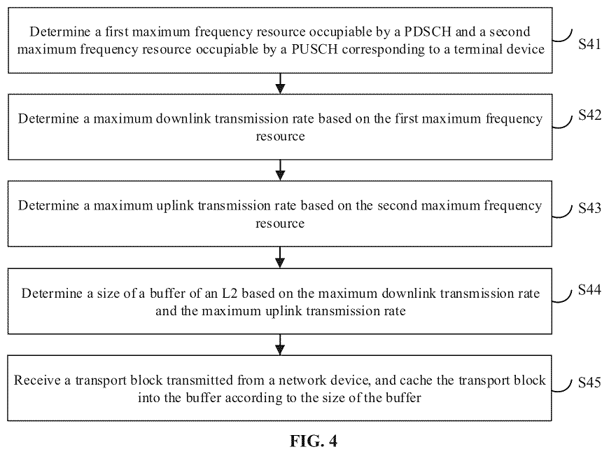

With reference to FIG. 3, FIG. 3 is a flowchart of a method for determining a size of a buffer of a data link layer L2 according to an embodiment of the present disclosure. The method for determining a size of a buffer of a data link layer L2 is performed by a terminal device. The method may include: S31, determining a maximum frequency resource occupiable by a data channel corresponding to the terminal device.

The buffer set by the terminal device for the L2 may not only cache the received transport block, but also cache a transport block to be reported. In other words, the buffer may be configured to cache an uplink transport block, and may also cache a downlink transport block. In the present disclosure, the maximum frequency resource occupiable by the data channel supported by the terminal device may include a first maximum frequency resource occupiable by the PDSCH and a second maximum frequency resource occupiable by the PUSCH.

S32, the size of the buffer of the L2 in the terminal device is determined based on the maximum frequency resource.

Alternatively, a maximum downlink transmission rate may be determined based on the first maximum frequency resource occupiable by the PDSCH, and a maximum uplink transmission rate may be determined based on the second maximum frequency resource occupiable by the PUSCH. Further, the size of the buffer of the L2 is determined based on the maximum uplink transmission rate and the maximum downlink transmission rate.

S33, a transport block transmitted from a network device is received, and the transport block is cached into the buffer according to the size of the buffer.

After the size of the buffer of the L2 is determined, the terminal device may receive the transport block transmitted from the network device and cache the transport block into the buffer within a limit of the size of the buffer.

According to a method for processing a transport block provided in the present disclosure, the size of the buffer of the L2 in the terminal device may be determined based on the maximum frequency resource occupiable by the data channel supported by the terminal device. In the present disclosure, the size of the buffer of the L2 is no longer determined by the maximum frequency resource of a BWP. Instead, the determined size of the buffer is adapted to the resource of the terminal device, eliminating the resource waste caused by the oversized buffer. In some scenarios, the resource waste caused by the oversized buffer can be eliminated, as can the overflow of received downlink transmission caused by the undersized buffer of the L2 of the terminal device.

It should be noted that a manner for determining the maximum frequency resource occupiable by the data channel corresponding to the terminal device may refer to the example in FIG. 2, which is not repeatedly described here. That is, both the first maximum frequency resource occupiable by the PDSCH and the second maximum frequency resource occupiable by the PUSCH may be determined in the manner shown in FIG. 2.

With reference to FIG. 4, FIG. 4 is a flowchart of a method for determining a size of a buffer of an L2 according to an embodiment of the present disclosure. The method for determining a size of a buffer of a data link layer L2 is performed by a terminal device. The method may include: S41, determining a first maximum frequency resource occupiable by a PDSCH and a second maximum frequency resource occupiable by a PUSCH corresponding to a terminal device.

Any implementation in the embodiments of the present disclosure may be used as an implementation of S41, which is not repeatedly described here.

S42, a maximum downlink transmission rate is determined based on the first maximum frequency resource.

S43, a maximum uplink transmission rate is determined based on the second maximum frequency resource.

Alternatively, the maximum frequency resource is the maximum number of physical resource blocks (PRBs) occupiable by the data channel. In other words, the maximum transmission rate of the terminal device may be determined based on the maximum number of PRBs occupiable by the data channel. In the present disclosure, the maximum downlink transmission rate may be determined based on the first maximum number of PRBs occupiable by the PDSCH, and the maximum uplink transmission rate may be determined based on the second maximum number of PRBs occupiable by the PUSCH.

A determining process of any one of the maximum downlink transmission rate and the maximum uplink transmission rate includes: obtaining a relevant transmission parameter of the terminal device that affects a transport block decision threshold, and determining any one of the maximum transmission rates according to the relevant transmission parameter and the maximum number of PRBs.

Alternatively, the relevant transmission parameter may include at least one of the following:
a maximum number of transmission layers of multiple input multiple output (MIMO) supported by the terminal device;
a maximum modulation and demodulation manner supported by the terminal device;
signaling overhead of the terminal device; or
a scaling factor of the terminal device.

As a possible implementation, any one of the maximum transmission rates is determined from the following formula:

$$data rate ( in Mbps ) = {10}^{- 6} \cdot {\sum }_{j = 1}^{J} ( {v}_{layers}^{( j )} \cdot {Q}_{m}^{( j )} \cdot {f}^{( j )} \cdot {R}_{max} \cdot \frac{{N}_{PRB} \cdot 12}{{T}_{s}^{μ}} \cdot ( 1 - O {H}^{( j )} ) )$$

where J is a number of carriers aggregated in a band or band combination; and Rₘₐₓ=948/1024.

For a j-th component carrier (CC),

$${V}_{Layers}^{( j )}$$

represents a maximum number of transmission layers supported by the terminal device for the j-th component carrier (CC). The maximum number of transmission layers is determined by a higher layer parameter supported by PDSCH downlink, i.e., a maximum number of MIMO layers, a highest layer parameter supported by contention-based PUSCH (CB-PUSCH) uplink, i.e., a maximum number of MIMO layers, and a highest layer parameter supported by non-contention-based PUSCH (CB-PUSCH) uplink, i.e., a maximum number of MIMO layers.

$${Q}_{m}^{( j )}$$

represents the maximum modulation and demodulation sequence supported by the terminal device. The maximum modulation and demodulation sequence is determined by an upper-level parameter of the downlink, that is, a modulation order supported by the downlink (supportedModulationOrderDL), and an upper-level parameter of the uplink, that is a modulation order supported by the uplink (supportedModulationOrderUL).

f^{(j)} is a scale factor supported by the terminal device. The scaling factor may be provided by a high-level parameter (scaling factor), and may take values of 1, 0.8, 0.75, and 0.4.

Further, μ is numerology.

$${T}_{s}^{μ}$$

is an average duration of an orthogonal frequency division multiplexing (OFDM) symbol in a subframe of the numerology μ, that is,

$${T}_{s}^{μ} = \frac{{10}^{- 3}}{{14.2}^{μ}} .$$

It is noted that normal cyclic prefixes are assumed here.

N_{PRB} is the maximum number of PRBs that can be used by the data channel supported by the terminal device.

OH^{(j)} is signaling overhead of the terminal device. OH^{(j)} may take a value of 0.14 for a downlink in a frequency range FR1. OH^{(j)} may take a value of 0.18 for a downlink in a frequency range FR2. OH^{(j)} may take a value of 0.08 for an uplink in a frequency range FR1. OH^{(j)} may take a value of 0.10 for an uplink in a frequency range FR2.

S44, a size of a buffer of an L2 is determined based on the maximum downlink transmission rate and the maximum uplink transmission rate.

As a possible implementation, the size of the buffer of the L2 may be obtained by summing the maximum uplink transmission rate and the maximum downlink transmission rate.

For example, L2 buffer size=MaxDLDataRate+MaxULDataRate

The L2 buffer size is configured to represent the size of the buffer of the L2, MaxDLDataRate is configured to represent the maximum uplink transmission rate, and MaxULDataRate is configured to represent the maximum downlink transmission rate.

The method for determining a size of a buffer of an L2 provided in the embodiment of the present disclosure further includes: S45, receiving a transport block transmitted from a network device, and caching the transport block into the buffer according to the size of the buffer.

After the size of the buffer of the L2 is determined, the terminal device may receive the transport block transmitted from the network device and cache the transport block into the buffer within a limit of the size of the buffer.

According to a method for processing a transport block provided in the present disclosure, the size of the buffer of the L2 in the terminal device may be determined based on the maximum frequency resource occupiable by the data channel corresponding to the terminal device. In the present disclosure, the size of the buffer of the L2 is no longer determined by the maximum frequency resource of a BWP. Instead, the determined size of the buffer is adapted to the resource of the terminal device, eliminating the resource waste caused by the oversized buffer. In some scenarios, the resource waste caused by the oversized buffer can be eliminated, as can the overflow of received downlink transmission caused by the undersized buffer of the L2 of the terminal device.

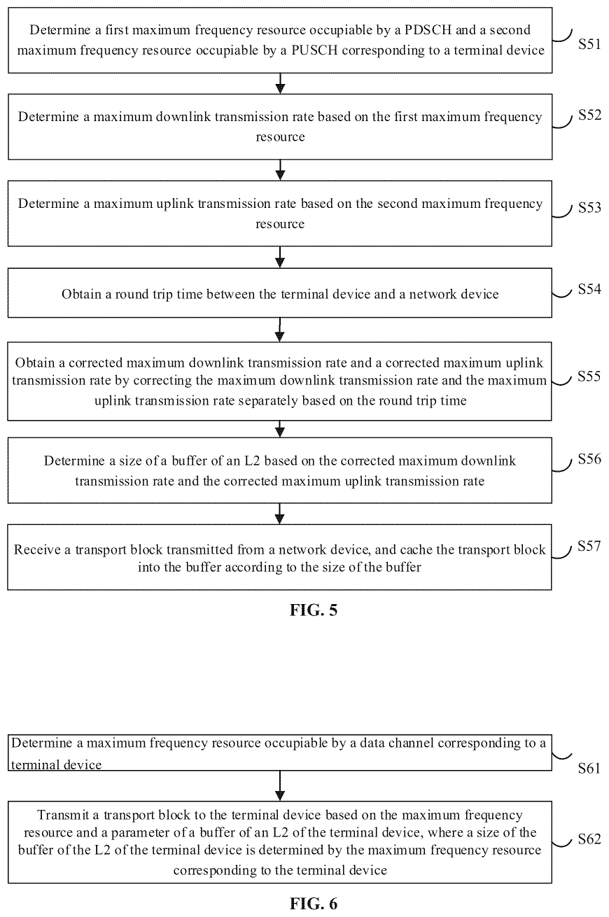

With reference to FIG. 5, FIG. 5 is a flowchart of a method for determining a size of a buffer of an L2 according to an embodiment of the present disclosure. The method for determining a size of a buffer of a data link layer L2 is performed by a terminal device. The method may include:
S51, determining a first maximum frequency resource occupiable by a PDSCH and a second maximum frequency resource occupiable by a PUSCH corresponding to a terminal device.
S52, determining a maximum downlink transmission rate based on the first maximum frequency resource.

S53, determining a maximum uplink transmission rate based on the second maximum frequency resource.

Any implementation in the embodiments of the present disclosure may be used as an implementation of S51-S53, which is not repeatedly described here.

S54, a round trip time between the terminal device and a network device is obtained.

Alternatively, the size of the buffer of the L2 is also affected by the round trip time (RTT). In some implementations, the RTT may be obtained by being predefined by a protocol, or being preconfigured by a network, or being indicated by the network device, or being measured by the terminal device or the network device.

In another implementation, a device type of the terminal device may be determined, and a mapping relationship between a candidate sub-carrier space (SCS) and a candidate RTT may be determined based on the device type. In other words, different SCSs correspond to different RTTs. Further, the mapping relationship is queried and the round trip time between the terminal device and the network device is determined, based on an SCS supported by the terminal device.

In the present disclosure, different mapping relationships may be preconfigured for different device types of terminal devices. Further, a mapping relationship corresponding to the terminal device may be determined from the plurality of mapping relationships preconfigured according to an actual device type of the terminal device. Based on the SCS supported by the terminal device, an RTT value corresponding to the SCS is queried from the corresponding mapping relationship.

For example, for a terminal device that does not support relaxing at a processing time, the mapping relationship may be as shown in Table 1.

| SCS (kHz) | RLC RTT (ms) |
|---|---|
| 15 KHz | 50 |
| 30 KHz | 40 |
| 60 KHz | 30 |
| 120 KHz | 20 |

A mapping relationship for a terminal device that supports relaxing at a processing time may be as shown in Table 2:

| SCS (kHz) | RLC RTT (ms) |
|---|---|
| 15 KHz | 50 + X |
| 30 KHz | 40 + Y |
| 60 KHz | 30 + Z |
| 120 KHz | 20 + M |

It may be understood that each element in Tables 1 and 2 is independent, and these elements are illustratively listed in the same table. But it does not mean that all the elements in the tables must be present at the same time as shown in the tables. A value of each element is independent of a value of any other element in Tables 1 and 2. Thus, those skilled in the art may understand that the value of each element in the Table 1 is an independent embodiment.

It should be noted that parameters X, Y, Z and M in Table 2 may be configured time offsets, which may be preconfigured by a protocol or a network.

S55, a corrected maximum downlink transmission rate and a corrected maximum uplink transmission rate are obtained by correcting the maximum downlink transmission rate and the maximum uplink transmission rate separately based on the round trip time.

Alternatively, the maximum downlink transmission rate and the maximum uplink transmission rate are corrected respectively by determining the round trip time as a correction coefficient. For example, the corrected maximum downlink transmission rate and the corrected maximum uplink transmission rate may be obtained by multiplying the round trip time by the maximum downlink transmission rate and the maximum uplink transmission rate respectively.

S56, a size of a buffer of an L2 is determined based on the corrected maximum downlink transmission rate and the corrected maximum uplink transmission rate.

Alternatively, the size of the buffer of the L2 may be determined by adding the corrected maximum downlink transmission rate and the corrected maximum uplink transmission rate.

$$L 2 buffer size = M a x D L DataRate ⋆ RLC RTT + MaxULDataRate * RLC RTT$$

The L2 buffer size is configured to represent the size of the buffer of the L2, MaxDLDataRate is configured to represent the maximum uplink transmission rate, and MaxULDataRate is configured to represent the maximum downlink transmission rate.

The method for determining a size of a buffer of an L2 provided in the embodiment of the present disclosure further includes: S57, receiving a transport block transmitted from a network device, and caching the transport block into the buffer according to the size of the buffer.

After the size of the buffer of the L2 is determined, the terminal device may receive the transport block transmitted from the network device and cache the transport block into the buffer within a limit of the size of the buffer.

According to a method for processing a transport block provided in the present disclosure, the size of the buffer of the L2 in the terminal device may be determined based on the maximum frequency resource occupiable by the data channel supported by the terminal device. In the present disclosure, the size of the buffer of the L2 is no longer determined by the maximum frequency resource of a BWP. Instead, the determined size of the buffer is adapted to the resource of the terminal device, eliminating the resource waste caused by the oversized buffer. In some scenarios, resource waste caused by the oversized buffer can be eliminated, and the overflow of received downlink transmission caused by the undersized buffer of the L2 of the terminal device can also be eliminated.

Corresponding to the foregoing embodiment on a terminal device side, the embodiment of the present disclosure further provides a method for determining a size of a buffer of an L2 performed by a network side device. Those skilled in the art may understand that the method of the network side device corresponds to the method of a terminal device side. Accordingly, explanation and description on the terminal device side are not repeatedly described in the embodiment of the network side device.

With reference to FIG. 6, FIG. 6 is a flowchart of a method for determining a size of a buffer of an L2 according to an embodiment of the present disclosure. The method for determining a size of a buffer of an L2 is performed by a network device. The method may include: S61, determining a maximum frequency resource occupiable by a data channel corresponding to a terminal device.

Alternatively, the maximum frequency resource occupiable by the data channel supported by the terminal device may be determined by the network device according to a protocol agreement or a capability report of the terminal device.

Corresponding to the embodiment of the terminal device side, the maximum frequency resource occupied by the data channel corresponding to the terminal device is no greater than a maximum bandwidth supported by the terminal device. Alternatively, the maximum frequency resource occupied by the data channel corresponding to the terminal device is no greater than a maximum bandwidth of a bandwidth part (BWP) configured for the terminal device. A frequency resource occupied by the data channel may be several PRBs continuous in frequency, also be several PRBs spaced in frequency. In other words, the frequency resource occupied by the data channel may be continuous or discontinuous in the BWP.

S62, a transport block is transmitted to the terminal device based on the maximum frequency resource and a parameter of a buffer of an L2 of the terminal device, where a size of the buffer of the L2 of the terminal device is determined by the maximum frequency resource corresponding to the terminal device.

Specifically, during transmission, data transmission may be performed according to the size of the buffer of the L2 in the terminal device. The data transmission may refer to downlink transmission from the network side device to the terminal device, or uplink transmission from the terminal device to the network side device. After the maximum frequency resource occupied by the data channel supported by the terminal device is determined, it may be determined whether to transmit the transport block to the terminal device based on the maximum frequency resource. In some scenarios, the resource waste caused by the oversized buffer can be eliminated, and the overflow of received downlink transmission caused by the undersized buffer of the L2 of the terminal device can also be eliminated.

Alternatively, the maximum frequency resource includes a first maximum frequency resource occupiable by a PDSCH. A maximum downlink transmission rate may be determined as a transport block decision threshold by the network device based on the first maximum frequency resource. The network device determines whether to transmit the transport block according to the transport block decision threshold.

In some implementations, the network device may determine a transmission rate of the transport block, and determine to transmit the transport block in response to determining that the transmission rate of the transport block is less than or equal to the transport block decision threshold; alternatively, the network device determines to discard the transmission of the transport block or to split the transport block for transmission in response to determining that the transmission rate of the transport block is greater than the transport block decision threshold.

Alternatively, after the transport block is transmitted from the network device to the terminal device, the transport block may be received by the terminal device. In order to eliminate the loss of the transport block due to decoding delay, the transport block may be cached in the buffer of the L2 by the terminal device. The size of the buffer of the L2 is determined by the maximum frequency resource occupiable by the data channel supported by the terminal device. A specific process may refer to description of relevant contents in the above embodiments, which are not repeatedly described here.

According to a method for processing a transport block provided in the present disclosure, the maximum transmission rate may be determined by the network device based on the maximum frequency resource occupiable by the data channel supported by the terminal device, and the transport block is transmitted to the terminal device based on the maximum transmission rate. In the present disclosure, the transport block decision threshold is no longer determined based on the maximum frequency resource of the BWP. Instead, the transmission decision of the network device on the transport block is more accurate, eliminating the loss of the transport block, and improving the correct transmission rate of the transport block. Moreover, the size of the buffer can be determined based on the maximum frequency resource occupiable by the data channel, such that the size of the buffer is adapted to the resource of the terminal device, and the resource waste caused by the oversized buffer is eliminated.

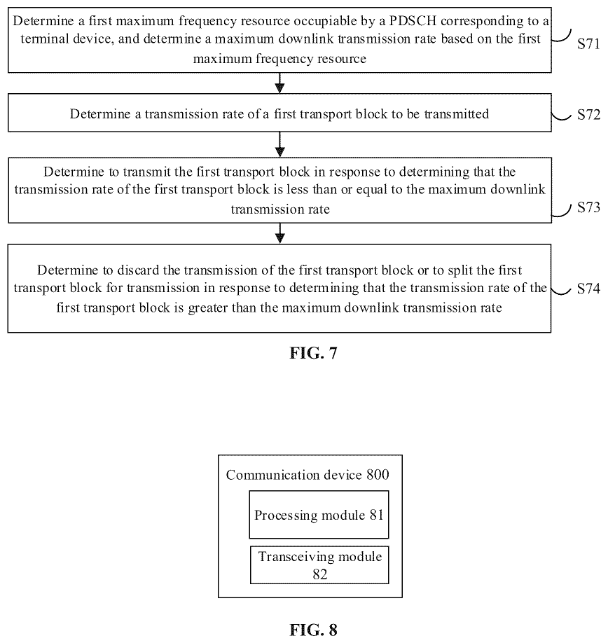

With reference to FIG. 7, FIG. 7 is a flowchart of a method for determining a size of a buffer of an L2 according to an embodiment of the present disclosure. The method for determining a size of a buffer of an L2 is performed by a network device. The method may include:
S71, determining a first maximum frequency resource occupiable by a PDSCH corresponding to a terminal device, and determining a maximum downlink transmission rate based on the first maximum frequency resource.

Alternatively, the maximum frequency resource is a first maximum number of PRBs occupiable by the PDSCH. That is, the maximum downlink transmission rate may be determined based on the first maximum number of PRBs occupiable by the PDSCH. In some implementations, a process for determining the maximum downlink transmission rate by the network device based on the first maximum number of PRBs includes: obtaining a relevant transmission parameter influencing the transmission rate and transmitted from the terminal device, and determining the maximum downlink transmission rate according to the relevant transmission parameter and the first maximum number of PRBs. Alternatively, the relevant transmission parameter may be reported from the terminal device to the network device. Correspondingly, the relevant transmission parameter reported by the terminal device is received by the network device.

Alternatively, the relevant transmission parameter may include at least one of the following:
a maximum number of transmission layers of multiple input multiple output (MIMO) supported by the terminal device;
a maximum modulation and demodulation sequence supported by the terminal device;
signaling overhead of the terminal device; or
a scaling factor of the terminal device.

A process for determining the maximum downlink transmission rate may refer to description of relevant contents in the above embodiments, which is not repeatedly described here.

Alternatively, a round trip time (RTT) between the terminal device and the network device may be obtained, and the maximum downlink transmission rate may be corrected based on the round trip time (RTT). That is, the corrected maximum downlink transmission rate is obtained by multiplying the RTT by the maximum downlink transmission rate.

Alternatively, a device type of the terminal device is determined and a mapping relationship between a candidate sub-carrier space (SCS) and a candidate round trip time is determined based on the device type. The round trip time between the terminal device and the network device is determined by querying the mapping relationship based on the SCS supported by the terminal device.

A process for correcting the maximum downlink transmission rate based on the RTT may refer to description of relevant contents in the above embodiments, which is not repeatedly described here.

S72, a transmission rate of a first transport block to be transmitted is determined.

In some implementations, the terminal device may determine a size of the first transport block and determine the transmission rate of the first transport block based on the size of the first transport block.

In other implementations, in response to transmitting a plurality of transport blocks in a single transmission time unit, a size of a transmitted second transport block is obtained, and a duration occupied by the single transmission time unit is determined. The transmission rate of the first transport block is determined based on a size of the first transport block, the size of the second transport block, and the duration occupied by the transmission time unit. Alternatively, the transmission time unit may be a slot, a subframe, an OFDM symbol, etc.

As a possible implementation, the transmission rate of the first transport block is determined from the following formula:

$${\sum }_{j = 0}^{J - 1} \frac{{\sum }_{m = 0}^{M - 1} {V}_{j , m}}{{T}_{slot}^{μ ( j )}}$$

J is a number of configured serving cells for a certain frequency range.

For a j-th serving cell, M is a number of transport blocks transmitted in slot sⱼ. In a case where there are two transport blocks in slot sⱼ with the same PDSCH transmission occasion (time domain or frequency domain), each transmission occasion needs to be calculated separately;

$${T}_{slot}^{μ ( j )} = 1 {0}^{- 3 / 2} ,$$

where μ(j) is numerology of PDSCH(s) in slot sⱼ in the j-th serving cell.

For an m-th TB,

$${V}_{j , m} = {C}^{′} \cdot [ \frac{A}{C} ] ;$$

A is a number of bits in the transport block; C is a total number of code blocks of the transport block; and C′ is a number of predetermined code blocks for the transport block.

S73, it is determined to transmit the first transport block in response to determining that the transmission rate of the first transport block is less than or equal to the maximum downlink transmission rate.

After the transmission rate of the first transport block and the transport block decision threshold are determined, it is necessary to compare a size of relationship the transmission rate of the first transport block with a size of the transport block decision threshold. Further, the network device determines whether to transmit the first transport block based on the size relationship. In a case where the transmission rate of the first transport block is compared to be less than or equal to the transport block decision threshold, the network device determines that the first transport block can be transmitted to the terminal device.

S74, it is determined to discard the transmission of the first transport block or to split the first transport block for transmission in response to determining that the transmission rate of the first transport block is greater than the maximum downlink transmission rate.

In a case where the network device obtains a result that the transmission rate of the first transport block compared to be greater than the transport block decision threshold, the network device determines that the first transport block cannot be transmitted to the terminal device. Alternatively, the network device may discard the transmission of the first transport block. Alternatively, the network device splits the first transport block into smaller transport blocks. As a result transmission rates of the split smaller transport blocks are no greater than the transport block decision threshold. The split smaller transport blocks are transmitted from the network device to the terminal device.

According to a method for processing a transport block provided in the present disclosure, the maximum transmission rate may be determined by the network device based on the maximum frequency resource occupiable by the data channel supported by the terminal device, and the transport block is transmitted to the terminal device based on the maximum transmission rate. In the present disclosure, the transport block decision threshold is no longer determined based on the maximum frequency resource of the BWP. Instead, the transmission decision of the network device on the transport block is more accurate, eliminating the loss of the transport block, and improving a correct transmission rate of the transport block. Moreover, the size of the buffer can be determined based on the maximum frequency resource occupiable by the data channel. In this way, the size of the buffer is adapted to the resource of the terminal device, and the resource waste caused by the oversized buffer is eliminated.

In the above embodiments provided in the present disclosure, the method provided by the embodiments of the present disclosure is introduced from the perspectives of a network device and a terminal device separately. In order to implement functions in the method provided in the above embodiments of the present disclosure, the network device and the terminal device may include a hardware structure and a software module. The above functions are implemented in a form of a hardware structure, a software module, or a hardware structure and a software module. A certain one of the above functions may be implemented in a method of a hardware structure, a software module, or a hardware structure and a software module.

With reference to FIG. 8, FIG. 8 is a schematic structural diagram of a communication device 800 according to an embodiment of the present disclosure is provided. The communication device 800 shown in FIG. 8 may include a transceiving module 82 and a processing module 81. The transceiving module 82 may include a transmitting module for implementing a transmitting function and/or a receiving module for implementing a receiving function. The transceiving module 82 may implement the transmitting function and/or the receiving function.

The communication device 800 may be a terminal device, a device in the terminal device, or a device that can be used in conjunction with the terminal device.

In a case where the communication device 800 is a terminal device, the processing module 81 is configured to determine a maximum frequency resource occupiable by a data channel corresponding to a terminal device; and determine a size of a buffer of an L2 in the terminal device based on the maximum frequency resource.

Alternatively, the processing module 81 is further configured to receive a transport block transmitted from a network device, and cache the transport block into the buffer according to the size of the buffer.

Alternatively, the maximum frequency resource includes a first maximum frequency resource occupiable by a physical downlink shared channel (PDSCH) and a second maximum frequency resource occupiable by a physical uplink shared channel (PUSCH), and the processing module 81 is further configured to determine a maximum downlink transmission rate based on the first maximum frequency resource, and determine a maximum uplink transmission rate based on the second maximum frequency resource; and determine the size of the buffer of the L2 based on the maximum downlink transmission rate and the maximum uplink transmission rate.

Alternatively, the maximum frequency resource is a maximum number of physical resource blocks (PRBs) occupiable by the data channel.

Alternatively, the maximum frequency resource occupied by the data channel is no greater than a maximum bandwidth of a bandwidth part (BWP) configured for the terminal device.

Alternatively, the processing module 81 is further configured to obtain a round trip time corresponding to the L2; obtain a corrected maximum downlink transmission rate and a corrected maximum uplink transmission rate by correcting the maximum downlink transmission rate and the maximum uplink transmission rate separately based on the round trip time; and determine the size of the buffer of the L2 based on the corrected maximum downlink transmission rate and the corrected maximum uplink transmission rate.

Alternatively, the processing module 81 is further configured to determine a device type of the terminal device, and determine a mapping relationship between a candidate sub-carrier space (SCS) and a candidate round trip time based on the device type; and determine the round trip time between the terminal device and the network device by querying the mapping relationship based on the SCS supported by the terminal device.

Alternatively, the processing module 81 is further configured to obtain a relevant transmission parameter of the terminal device influencing the transmission rate; and determine any one of the transmission rates according to the relevant transmission parameter and a number of PRBs.

Alternatively, the relevant transmission parameter includes at least one of the following: a maximum number of transmission layers of multiple input multiple output (MIMO) supported by the terminal device; a maximum modulation and demodulation sequence supported by the terminal device; signaling overhead of the terminal device; or a scaling factor of the terminal device.

In the embodiments of the present disclosure, the size of the buffer of the L2 is no longer determined by the maximum frequency resource of a BWP. Instead, the determined size of the buffer is adapted to a resource of the terminal device, eliminating the resource waste caused by the oversized buffer.

In a case where the communication device 800 is a network device, the transceiving module 82 is configured to determine a maximum frequency resource occupiable by a data channel corresponding to a terminal device, and transmit a transport block to the terminal device based on the maximum frequency resource and according to a parameter of a buffer of an L2 of the terminal device, where a size of the buffer of the L2 is determined by the maximum frequency resource.

Alternatively, the maximum frequency resource includes the first maximum frequency resource occupiable by a PDSCH, and the transceiving module 82 is further configured to determine a maximum downlink transmission rate based on the first maximum frequency resource; and transmit the transport block to the terminal device based on the maximum downlink transmission rate.

Alternatively, the maximum frequency resource is a maximum number of physical resource blocks (PRBs) occupiable by the data channel.

Alternatively, the maximum frequency resource occupied by the data channel is no greater than a maximum bandwidth of a bandwidth part (BWP) configured for the terminal device.

Alternatively, the transceiving module 82 is further configured to receive a relevant transmission parameter transmitted from the terminal device and influencing the transmission rate; and determine any one of the transmission rates according to the relevant transmission parameter and the maximum number of the PRBs.

Alternatively, the relevant transmission parameter includes at least one of the following: a maximum number of transmission layers of multiple input multiple output (MIMO) supported by the terminal device; a maximum modulation and demodulation sequence supported by the terminal device; signaling overhead of the terminal device; or a scaling factor of the terminal device.

Alternatively, the transceiving module 82 is further configured to obtain a round trip time corresponding to the L2; and obtain a corrected maximum downlink transmission rate by correcting the maximum downlink transmission rate based on the round trip time.

Alternatively, the transceiving module 82 is further configured to determine a device type of the terminal device, and determine a mapping relationship between a candidate sub-carrier space (SCS) and a candidate round trip time based on the device type; and determine the round trip time between the terminal device and the network device by querying the mapping relationship based on the SCS supported by the terminal device.

In the embodiments of the present disclosure, the size of the buffer of the L2 is no longer determined by the maximum frequency resource of a BWP. Instead, the determined size of the buffer is adapted to a resource of the terminal device, eliminating the resource waste caused by the oversized buffer.

With reference to FIG. 9, FIG. 9 is a schematic structural diagram of another communication device 900 according to an embodiment of the present disclosure. The communication device 900 may be a terminal device, may be a network device, may be a chip, a chip system, or a processor, etc. that supports the terminal device to implement the above method, and may also be a chip, a chip system, or a processor, etc. that supports the network device to implement the above method. The device may be configured to implement the methods described in the above method embodiments, which may refer to description in the above method embodiments for details.

The communication device 900 may include one or more first processors 91. The first processor 91 may be a general purpose processor or a special purpose processor, etc., such as a baseband processor or a central processor. The baseband processor may be configured to process a communication protocol and communication data. The central processor may be configured to control a communication device (for example, a base station, a baseband chip, a terminal device, a terminal device chip, a DU or a CU), to perform a computer program, and process data of the computer program.

Alternatively, the communication device 900 may further include one or more first memories 92 on which a second computer program 94 may be stored. The first processor 91 executes the second computer program 94 to cause the communication device 900 to perform the method described in the above method embodiments. Alternatively, the first memory 92 may also store data. The communication device 900 and the first memory 92 may be arranged separately or may be integrated together.

Alternatively, the communication device 900 may further include a transceiver 95 and an antenna 98. The transceiver 95 may be referred to as a transceiving unit, a transceiving machine, a transceiving circuit, etc., for implementing a transceiving function. The transceiver 95 may include a receiver and a transmitter. The receiver may be referred to as a receiving machine or a receiving circuit, etc., for implementing a reception function. The transmitter may be referred to as a transmitting machine, a transmitting circuit, etc., for implementing a transmission function.

Alternatively, the communication device 900 may further include one or more interface circuits 97. The interface circuit 97 is configured to receive code instructions and transmit the code instructions to the first processor 91. The first processor 91 runs the code instructions to cause the communication device 900 to implement the method described in the above method embodiments.

In an implementation, the first processor 91 may include a transceiver for implementing a reception function and a transmission function. For example, the transceiver may be a transceiving circuit, or an interface, or an interface circuit. The transceiving circuit, interface, or interface circuit for implementing the reception function and the transmission function may be separated or integrated. The transceiving circuit, interface or interface circuit described above may be configured to read and write a code/data, and alternatively, the transceiving circuit, interface or interface circuit described above may be configured to transmit or transfer a signal.

In an implementation, the first processor 91 may store a first computer program 93. The first computer program 93 runs on the first processor 91 and may cause the communication device 900 to perform the method described in the method embodiments above. The first computer program 93 may be embedded in the first processor 91. In this case, the first processor 91 may be implemented by hardware.

In an implementation, the communication device 900 may include a circuit that may implement the functions of transmission, or reception or communication in the foregoing method embodiments. The processor and transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be fabricated by using various IC process technologies, such as a complementary metal oxide semiconductor (CMOS), an metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs), etc.

The communication device described in the above embodiment may be a transmitting device or a receiving device (such as the receiving device in the foregoing method embodiments), but the scope of the communication device described in the present disclosure is not limited to this, and a structure of the communication device may not be limited by FIG. 8. The communication device may be an independent device or may be part of a large device. For example, the communication device may be:
(1) an independent integrated circuit (IC), or a chip, or a chip system or a subsystem;
(2) a set of one or more ICs, alternatively, including a memory component for storing data and a computer program;
(3) the ASIC, such as a modem;
(4) a module that can be embedded in other devices;
(5) a receiver machine, a terminal device, a smart terminal device, a cellular phone, a wireless device, a handset, a mobile unit, a vehicle-mounted device, a network device, a cloud device, an artificial intelligence device, etc.; and
(6) other devices, etc.

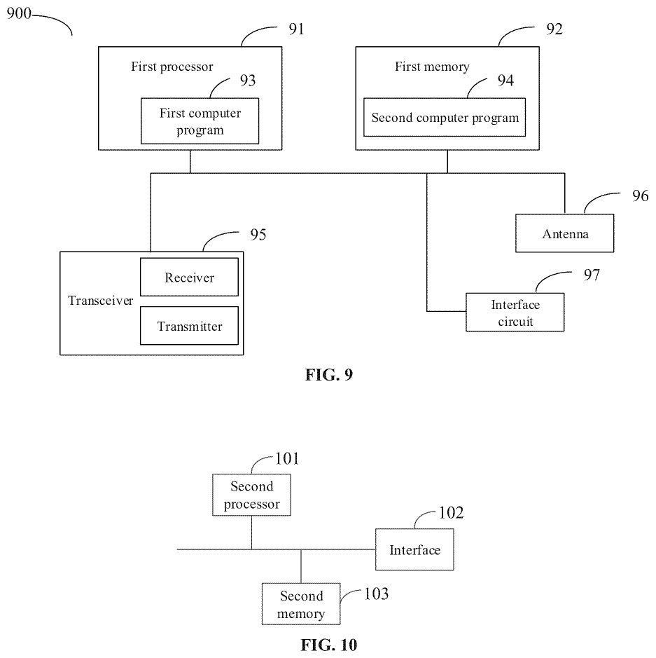

Reference may be made to a schematic structural diagram of a chip shown in FIG. 10 for the case that the communication device may be a chip or a chip system. The chip shown in FIG. 10 includes a second processor 101 and an interface 102. One or more second processors 101 may be provided. A plurality of interfaces 102 may be provided.

Alternatively, the chip further includes a second memory 103 for storing a necessary computer program and data.

The chip is configured to perform the functions of any one of the above method embodiments when performed.

Those skilled in the art will further appreciate that various illustrative logical blocks and steps set forth in the embodiments of the present disclosure may be implemented by electronic hardware, computer software, or combinations of both. Whether such functions are implemented by hardware or software depends on a particular application and design requirements of the overall system Those skilled in the art may use various methods to implement the functions for each particular application, but such implementation should not be understood as beyond the protection scope of the embodiments of the present disclosure.

The embodiments of the present disclosure further provide a communication system for physical sidelink control channel (PSCCH) transmission. The system includes the communication device served as a terminal device in the embodiment of FIG. 6. Alternatively, the system includes the communication device served as a terminal device in the embodiment of FIG. 8.

The present disclosure further provides a non-transitory readable storage medium on which the readable storage medium is stored. The instructions implements the functions of any one of the method embodiments when executed by a computer.

The present disclosure further provides a computer program product. The computer program product implements the functions of the method embodiments when executed by a computer.

In the embodiments of the present disclosure, the size of the buffer of the L2 is no longer determined by the maximum frequency resource of a BWP. Instead, the determined size of the buffer is adapted to the resource of the terminal device, eliminating the resource waste caused by the oversized buffer. In some scenarios, the resource waste caused by the oversized buffer can be eliminated, and the overflow of received downlink transmission caused by the undersized buffer of the L2 of the terminal device can also be eliminated.

The embodiments described above can be implemented in whole or in part by software, hardware, firmware, or their any combinations. When implemented through the software, the embodiments described above may be implemented in the form of computer program products. The computer program product includes one or more computer programs. When loaded and executed on a computer, the computer programs generate in whole or in part the flows or functions described in accordance with the embodiments of the present disclosure. The computer may be a general-purpose computer, a special-purpose computer, a computer network, or another programmable device. The computer program may be stored in a non-transitory computer-readable storage medium or transmitted from one non-transitory computer-readable storage medium to another non-transitory computer-readable storage medium. For example, the computer program can be transmitted from one website, computer, server, or data center to another website, computer, server, or data center through a wired means (for example, a coaxial cable, an optical fiber, and a digital subscriber line (DSL)) or through a wireless means (for example, infrared, radio waves, and microwaves). The non-transitory computer-readable storage medium may be any available medium that can be accessed by a computer or a data storage device including one or more available media integrated server, a data center, etc. The available medium may be a magnetic medium (for example, a floppy disk, a hard disk, a magnetic tape), an optical medium (for example, a digital video disk (DVD)), or a semiconductor medium (for example, a solid state disk (SSD)), etc.

Those skilled in the art may understand that the first, second and other numerical numbers involved in the present disclosure are merely for distinction for convenience of description, instead of limiting the scope of the embodiments of the present disclosure, and also represent the order of sequence.

At least one in the present disclosure may also be described as one or more, and the plurality may be two, three, four, or more, which is not limited in the present disclosure. In the embodiments of the present disclosure, for a type of technical features, technical features in this type of the technical features are distinguished by “first”, “second”, “third”, “A”, “B”, “C” and “D”, and the technical features described by the “first”, “second”, “third”, “A”, “B”, “C” and “D” are not in order of sequence or order of magnitude.

Corresponding relationships shown in tables of the present disclosure may be configured or predefined. Values of information in each table are only instances, and may be configured differently, which is not limited in the present disclosure. In a case where a correspondence relationship between the information and each parameter is configured, it is not necessarily required to configure all the correspondence relationships indicated in each table. For example, in the tables of the present disclosure, the corresponding relationships shown in some rows may not be configured. For another example, appropriate modification adjustments, such as splitting, merging, etc., can be made based on the above table. Names of the parameters shown in the titles of the above tables may also be other names that can be understood by the communication device, and values or expression modes of the parameters may also be other values or expression modes that can be understood by the communication device. In a case where the tables are implemented, other data structures may also be used, such as an array, a queue, a container, a stack, a linear table, a pointer, a linked list, a tree, a graph, a structure, a class, a heap, and a hash table, etc.

Predefinition in the present disclosure may be understood as definition, predefinition, storage, pre-storage, pre-negotiation, pre-configuration, curing, or pre-firing.

Those of ordinary skill in the art may appreciate that the units and algorithm steps of the instances described in conjunction with the embodiments disclosed here may be implemented in electronic hardware, or a combination of computer software and electronic hardware. Whether these functions are performed with hardware or software depends on the specific application and design constraints of the technical solution. Those skilled in the art can use different methods to implement the described functions for each particular application, but such implementation should not be deemed as falling beyond the scope of the present disclosure.

Those skilled in the art will clearly appreciate that, for convenience and conciseness of description, reference can be made to corresponding processes in the foregoing method embodiments for specific working processes of the above systems, devices and units, which are not repeatedly described here.

What are described above are merely particular embodiments of the present disclosure, but are not intended to limit the scope of protection of the present disclosure, and any changes or substitutions that can readily occur to those skilled in the art within the scope of technology disclosed in the present disclosure should fall within the scope of protection of the present disclosure. Thus, the scope of protection of the present disclosure should be subject to the scope of protection of the claims.

1. A method for determining a size of a buffer of a data link layer L2, performed by a terminal device, the method comprising:
determining a maximum frequency resource occupiable by a data channel corresponding to the terminal device; and
determining the size of the buffer of the data link layer L2 in the terminal device based on the maximum frequency resource.

2. The method according to claim 1, wherein after determining the size of the buffer of the data link layer L2 in the terminal device, the method further comprises:
receiving a transport block transmitted from a network device; and
caching the transport block into the buffer according to the size of the buffer.

3. The method according to claim 1, wherein
the maximum frequency resource comprises a first maximum frequency resource occupiable by a physical downlink shared channel (PDSCH) and a second maximum frequency resource occupiable by a physical uplink shared channel (PUSCH); and
determining the size of the buffer of the data link layer L2 based on the maximum frequency resource comprises:
determining a maximum downlink transmission rate based on the first maximum frequency resource;
determining a maximum uplink transmission rate based on the second maximum frequency resource; and
determining the size of the buffer of the data link layer L2 based on the maximum downlink transmission rate and the maximum uplink transmission rate.

4. The method according to claim 3, wherein the maximum frequency resource is a maximum number of physical resource blocks (PRBs) occupiable by the data channel.

5. The method according to claim 1, wherein the maximum frequency resource occupied by the data channel is no greater than a maximum bandwidth of a bandwidth part (BWP) configured for the terminal device.

6. The method according to claim 3, wherein determining the size of the buffer of the data link layer L2 based on the maximum downlink transmission rate and the maximum uplink transmission rate comprises:
obtaining a round trip time between the terminal device and a network device;
obtaining a corrected maximum downlink transmission rate and a corrected maximum uplink transmission rate by correcting the maximum downlink transmission rate and the maximum uplink transmission rate respectively based on the round trip time; and
determining the size of the buffer of the data link layer L2 based on the corrected maximum downlink transmission rate and the corrected maximum uplink transmission rate.

7. The method according to claim 6, wherein obtaining the round trip time between the terminal device and the network device comprises:
determining a device type of the terminal device;
determining a mapping relationship between a candidate sub-carrier space (SCS) and a candidate round trip time based on the device type; and
determining the round trip time between the terminal device and the network device by querying the mapping relationship based on the SCS supported by the terminal device.

8. The method according to claim 4, wherein a determining process of one of the maximum downlink transmission rate and the maximum uplink transmission rate comprises:
obtaining a relevant transmission parameter of the terminal device that affects the transmission rate; and
determining one of the transmission rates according to the relevant transmission parameter and the maximum number of the PRBs.

9. The method according to claim 8, wherein the relevant transmission parameter comprises at least one of:
a maximum number of transmission layers of multiple input multiple output (MIMO) supported by the terminal device;
a maximum modulation and demodulation sequence supported by the terminal device;
signaling overhead of the terminal device; or
a scaling factor of the terminal device.

10. A method for determining a size of a buffer of a data link layer L2, performed by a network device, the method comprising:
determining a maximum frequency resource occupied by a data channel corresponding to a terminal device; and
transmitting a transport block to the terminal device based on the maximum frequency resource and according to a parameter of the buffer of the data link layer L2 of the terminal device, wherein the size of the buffer of the data link layer L2 of the terminal device is determined by the maximum frequency resource.

11. The method according to claim 10, wherein
the maximum frequency resource comprises a first maximum frequency resource occupiable by a PDSCH; and
transmitting the transport block to the terminal device based on the maximum frequency resource and according to the parameter of the buffer of the data link layer L2 of the terminal device comprises:
determining a maximum downlink transmission rate based on the first maximum frequency resource; and
transmitting the transport block to the terminal device based on the maximum downlink transmission rate and according to the parameter of the buffer of the data link layer L2 of the terminal device; or
the maximum frequency resource occupied by the data channel is no greater than a maximum bandwidth of a bandwidth part (BWP) supported by the terminal device.

12. The method according to claim 11, wherein the maximum frequency resource is a maximum number of physical resource blocks (PRBs) occupiable by the data channel.

13. (canceled)

14. The method according to claim 12, wherein determining the maximum downlink transmission rate based on the first maximum frequency resource comprises:
receiving a relevant transmission parameter transmitted from the terminal device that affects the transmission rates; and
determining one of the transmission rates according to the relevant transmission parameter and the maximum number of the PRBs.

15. The method according to claim 14, wherein the relevant transmission parameter comprises at least one of the following:
a maximum number of transmission layers of multiple input multiple output (MIMO) supported by the terminal device;
a maximum modulation and demodulation sequence supported by the terminal device;
signaling overhead of the terminal device; or
a scaling factor of the terminal device.

16. The method according to claim 14, wherein determining the maximum downlink transmission rate based on the first maximum frequency resource comprises:
obtaining a round trip time between the network device and the terminal device; and
obtaining a corrected maximum downlink transmission rate by correcting the maximum downlink transmission rate based on the round trip time.

17. The method according to claim 16, wherein obtaining the round trip time between the terminal device and the network device comprises:
determining a device type of the terminal device;
determining a mapping relationship between a candidate sub-carrier space (SCS) and a candidate round trip time based on the device type; and
determining the round trip time between the network device and the terminal device by querying the mapping relationship based on the SCS supported by the terminal device.

18-19. (canceled)

20. A communication device, comprising:
one or more processors; and
a memory that stores a computer program, wherein
the one or more processors execute the computer program stored in the memory to cause the communication device to determine a maximum frequency resource occupiable by a data channel corresponding to a terminal device; and determine a size of a buffer of a data link layer L2 in the terminal device based on the maximum frequency resource.

21. A communication device, comprising:
one or more processors; and
a memory that stores a computer program, wherein
the one or more processors execute the computer program stored in the memory to cause the communication device to perform the method according to claim 10.

22-23. (canceled)

24. A non-transitory computer-readable storage medium storing instructions, wherein the instructions, when executed by one or more processors, the one or more processors implement the method according to claim 1.

25. A non-transitory computer-readable storage medium storing instructions, wherein the instructions, when executed by one or more processors, the one or more processors implement the method according to claim 10.
